(19) United States
(12) Patent Application Publication
(10) Pub. No.: US 2024/0334108 A1
(43) Pub. Date: Oct. 3, 2024

(54) FILTER DEVICE FOR A HEARING DEVICE, A HEARING DEVICE, A METHOD OF MANUFACTURING A FILTER DEVICE, AND A METHOD OF ASSEMBLING A HEARING DEVICE

(71) Applicant: GN Hearing A/S, Ballerup (DK)

(72) Inventors: Jakob BRINCK, Ballerup (DK); Finn HANSEN, Smørum (DK); Tharsiny THANENDRAN, Copenhagen (DK)

(73) Assignee: GN Hearing A/S, Ballerup (DK)

(21) Appl. No.: 18/425,837

(22) Filed: Jan. 29, 2024

(30) Foreign Application Priority Data
Mar. 31, 2023 (EP) 23165815.4

(51) Int. Cl. H04R 1/08; H04R 1/10

(52) U.S. Cl. CPC H04R 1/086; H04R 1/1075

(57) ABSTRACT

Disclosed is a filter device, a hearing device, a method of assembling a hearing device, and a method of manufacturing a filter device. The method of manufacturing the filter device comprises providing a mesh, a first adhesive element, and a second adhesive element. The method further comprises arranging the first adhesive element and the second adhesive element on opposite surfaces of the mesh at a second portion of the mesh to obtain a filter assembly. The second portion of the mesh surrounds a first portion of the mesh. The method further comprises applying a predetermined force to the filter assembly for a predetermined period of time, thereby obtaining a filter device comprising a closed portion of the filter device at the second portion of the mesh, and comprising an open portion of the filter device at the first portion of the mesh.

### RELATED APPLICATION DATA

This application claims priority to, and the benefit of, European Patent Application No. 23165815.4 filed on Mar. 31, 2023, pending. The entire disclosure of the above application is expressly incorporated by reference.

### FIELD

The present disclosure relates to hearing devices. More specifically, the disclosure relates to a filter device for a hearing device, a hearing device, a method of manufacturing a filter device, and a method of assembling a hearing device.

### BACKGROUND

Hearing devices typically comprise microphones within a hearing device housing to receive sound from surroundings and direct the sound into an ear of a user. A protective element is often arranged between a sound inlet of the hearing device housing and a microphone opening of the microphone. The protective element prevents dusts and particles from entering into the microphone opening while it allows sound to pass through the protective element to reach the ear of the user. However, sound may leak into the microphone in an unwanted manner. This may in turn adversely affect a performance of the hearing device. For instance, such sound leakages may be perceived as noise and may adversely affect the performance of the hearing device. Therefore, there is a need to provide an improved protective element as well as an improved method of manufacturing such protective element. In addition, there is a need to provide an improved hearing device as well as an improved method of assembling such hearing device comprising such protective element.

### SUMMARY

According to a first aspect, disclosed is a method of manufacturing a filter device. The method comprises providing a mesh, a first adhesive element, and a second adhesive element. The method further comprises arranging the first adhesive element and the second adhesive element on opposite surfaces of the mesh at a second portion of the mesh to obtain a filter assembly. The second portion of the mesh surrounds a first portion of the mesh. The method further comprises applying a predetermined force to the filter assembly for a predetermined period of time, thereby obtaining a filter device comprising a closed portion of the filter device at the second portion of the mesh, and comprising an open portion of the filter device at the first portion of the mesh.

It is an advantage that the applying of the predetermined force to the filter assembly for the predetermined period of time allows for obtaining the closed portion of the filter device. This is because, by applying the predetermined force to the filter assembly for the predetermined period of time, openings/holes of the mesh at the second portion of the mesh become completely or at least partially filled with adhesive material of the first adhesive element and/or the second adhesive element.

After applying the predetermined force, a height of the closed portion of the filter device, may be lower than a height of the filter assembly at the second portion. For instance, after applying the predetermined force, the height of the closed portion of the filter device, may be 0 to 5% less than of the height of the filter assembly at the second portion. By the height of the filter device or a height of the filter assembly is hereby meant a respective dimension of the filter device or the filter assembly in a direction parallel to normal planes of the two opposite surfaces of the mesh.

The applying of the predetermined force to the filter assembly for the predetermined period of time may be performed at room temperature. The applying of the predetermined force to the filter assembly for the predetermined period of time may be performed at a temperature in the range of 15° C. to 25° C. The applying of the predetermined force to the filter assembly for the predetermined period of time may be performed at a temperature higher than the room temperature. The applying of the predetermined force to the filter assembly may comprise applying a heat to the filter assembly. The applying of the heat to the filter assembly may be performed using heated plates for the pressing. The applying of the heat to the filter assembly may be performed by applying heat to the filter assembly before pressing. A time for applying of the heat to the filter assembly may be the same as the predetermined period of time. For instance, the applying of the heat and the applying of the predetermined force to the filter assembly may be performed simultaneously. Alternatively, the time for applying of the heat to the filter assembly may not be the same as the predetermined period of time. In other words, the time for applying of the heat to the filter assembly may be shorter or longer than the predetermined period of time. For instance, the time for applying of the heat to the filter assembly may be half of the predetermined period of time.

The applying of the heat to the filter assembly may be performed simultaneously with the applying of the predetermined force to the filter assembly. The applying of the heat to the filter assembly may not be performed simultaneously with the applying of the predetermined force to the filter assembly. The applying of the heat to the filter assembly may partially overlap with the applying of the predetermined force to the filter assembly. For instance, the applying of the heat to the filter assembly may begin prior to the applying of the predetermined force to the filter assembly and may end prior to the predetermined period of time.

The second portion of the mesh surrounds the first portion of the mesh. Thereby, the second portion may be an outer portion of the filter device e.g. an edge portion of the filter device. The first portion may be an inner portion of the filter device e.g. a central portion of the filter device.

The opposite sides of the mesh may correspond to two main surfaces of the mesh arranged opposite to one another. One of the opposite surfaces of the mesh may face the first adhesive element and the other one of the opposite surfaces of the mesh may face the second adhesive layer, subsequent to the arranging of the first adhesive element and the second adhesive element on opposite surfaces of the mesh. The mesh may be a mesh sheet. In the case of the mesh sheet, the opposite surfaces may correspond to two surfaces of the mesh sheet.

It is an advantage to obtain a closed portion of the filter device, such as a closed edge portion of the filter device, i.e. an acoustically sealed portion of the filter device. The closed portion of the filter device does not allow for passage of sound through the closed portion i.e. blocks for transmission/travel of sound. The closed portion of the filter device does not allow for sound to be transmitted and/or travel through the closed portion in any direction through the closed portion. The closed portion of the filter device does not allow for sound to be transmitted and/or travel through an edge of the closed portion in any direction through the closed portion. This is because the openings or holes of the mesh at the closed portion of the filter device are closed and hence sound cannot travel through them.

It is an advantage to obtain an open portion of the filter device i.e. an acoustically open portion of the filter device. Thereby, the open portion of the filter device allows for passage/travel/transmission of sound through the openings/holes of the mesh of the filter device at the first portion of the mesh.

In overall, it is an advantage of the first aspect to obtain an improved filter device that prevents or at least mitigates sound leakage into/through the closed portion of the filter device. Thereby, it allows for an improved filter device in terms of stability, quality, and increased acoustical sound performance.

The first adhesive element may comprise one or two first adhesive layer(s) and a first support. The first adhesive element may be provided in the form of a sheet. For instance, first adhesive element may be a single-sided or a double-sided tape. The second adhesive element may comprise one or two second adhesive layers and a second support. The second adhesive element may be provided in the form of a sheet. For instance, the second adhesive element may be a single-sided or a double-sided tape. The first adhesive layer(s) may be made of the same adhesive material as the second adhesive layer(s). The first adhesive layer(s) may not be made of the same adhesive material as the second adhesive layer(s) i.e. the first adhesive layer(s) may be made of a different adhesive material than the second adhesive layer(s).

The mesh may be any conventional and commercially available mesh, suitable for a filter device. The mesh may be provided in the form of a mesh sheet. The mesh may comprise a woven fabric or a textile. The mesh may comprise a plurality of openings or holes. The mesh may be configured to prevent dust and particles from passing through the openings or holes. A size of the opening or holes may be at least 15 μm. The size of the opening or holes may be smaller than a size of typical dust and/or typical particles. Thus, the dust and/or particles with sizes larger than the size of the opening or holes may not pass through the opening or holes of the mesh. The mesh may be configured to have little or no impact on the level of sound in the range 200 Hz to 5000 Hz at the microphones. The filter device may comprise at least a closed portion of the filter device. The filter device may comprise at least an open portion of the filter device.

In some embodiments, applying the force comprises pressing the first adhesive element and the second adhesive element into the second portion of the mesh.

Thereby, the applying of the force comprises by pressing the first adhesive element and the second adhesive element into the second portion of the mesh may be performed in a simple and user-friendly manner. The pressing of the first adhesive element and the second adhesive element into the second portion of the mesh may be performed by placing a predetermined load on the filter assembly. The pressing of the first adhesive element and the second adhesive element into the second portion of the mesh may be performed using a device e.g. a pressing device.

In some embodiments, the predetermined force is at least 0.2 MPa and the predetermined period of time is at least 1 sec.

Thereby, the applying of the predetermined force to the filter assembly for the predetermined period of time may be performed within a short time i.e. in a time-effective manner. For instance, the predetermined force may be 0.7 MPa and the predetermined period of time may be 5 sec.

In some embodiments, each of the first adhesive element and the second adhesive element comprises at least one perforation, and wherein arranging the first adhesive element and the second adhesive element comprises aligning the at least one perforation of the first adhesive element with the at least one perforation of the second adhesive element at the second portion of the mesh.

Thereby, the arranging the first adhesive element and the second adhesive element on opposite surfaces of the mesh at a second portion of the mesh to obtain a filter assembly may comprise aligning a perforation in the first adhesive element with a perforation in the second adhesive element. Aligning the perforation in the first adhesive element with the perforation in the second adhesive element may comprise aligning the outer periphery of the perforation in the first adhesive element with the perforation in the second adhesive element.

In case the mesh, first adhesive element and the second adhesive element are provided as a mesh sheet, a first adhesive sheet and a second adhesive sheet, the aligning the at least one perforation of the first adhesive sheet with the at least one perforation of the second adhesive sheet may comprise aligning an edge or periphery of the mesh sheet, the first adhesive sheet and the second adhesive sheet. The at least one perforation of each of the first adhesive element and the second adhesive element may define/form the open portion of the filter device. The at least one perforation of the first adhesive element may have the same shape as the least one perforation of the second adhesive element such as a circular shape or an oval shape. The at least one perforation of the first adhesive element may have the same size as the at least one perforation of the second adhesive element. A size of the filter device along the two opposite surfaces of the mesh i.e. along a direction perpendicular to normal planes of the two opposite surfaces of the mesh may be at least 0.025 mm. For instance, the filter device may have a circular shape with a diameter of at least 2 mm. A size of the at least one perforation of each of the first adhesive element and the second adhesive element along the two opposite surfaces of the mesh may be at least 0.5 mm. In combination with the mesh, the first adhesive element and the second adhesive element being in the form of the mesh sheet, the first adhesive sheet and the second adhesive sheet, the first portion of the mesh may correspond to portions of the mesh sheet at/in between one or more perforations of first adhesive sheet and the second adhesive sheet. The second portion of the mesh may correspond to portions of the mesh sheet covered by the first adhesive sheet and the second adhesive sheet.

In some embodiments, the mesh is provided as a mesh sheet and the first adhesive element and the second adhesive element are provided as a first adhesive sheet and a second adhesive sheet, respectively. The method further comprises cutting the filter assembly into one or more cut-out filter device(s) subsequent to applying the predetermined force for the predetermined period of time.

The mesh sheet, the first adhesive sheet and the second adhesive sheet may be provided as a roll of mesh sheet, a roll of first adhesive sheet and a roll of second adhesive sheet.

Thereby, the providing the mesh, the first adhesive element, and the second adhesive element may comprise providing a mesh sheet, a first adhesive sheet and a second adhesive sheet, respectively.

Thereby, the arranging the first adhesive element and the second adhesive element on opposite surfaces of the mesh at a second portion of the mesh to obtain a filter assembly may comprise aligning the mesh sheet, the first adhesive sheet and the second adhesive sheet, respectively. Aligning the mesh sheet, the first adhesive sheet and the second adhesive sheet may comprise aligning an edge or periphery of the mesh sheet, the first adhesive sheet and the second adhesive sheet, respectively.

It is an advantage that by using the first adhesive sheet and the second adhesive sheet, a plurality of filter devices may be obtained in one cutting step. The cutting of the filter assembly into one or more filter device(s) may comprise cutting an outer periphery of the one or more filter device(s). The cutting of the filter assembly into one or more filter device(s) may comprise cutting the outer periphery of the one or more filter device(s) in a desired size and shape e.g. a circular or on oval shape.

In some embodiments, the mesh, the first adhesive element and the second adhesive element are provided as a mesh, a first adhesive element and a second adhesive element (separately) cut into one or more filter shape(s). The method further comprises separately cutting the mesh, the first adhesive element and the second adhesive element into one or more filter shape(s) prior to arranging the first adhesive element and the second adhesive element on opposite surfaces of the mesh.

Thereby, the providing the mesh, the first adhesive element, and the second adhesive element may comprise providing a mesh, a first adhesive element and a second adhesive element, separately cut into one or more filter shape(s).

Thereby, the arranging the first adhesive element and the second adhesive element on opposite surfaces of the mesh at a second portion of the mesh to obtain a filter assembly may comprise aligning the mesh, the first adhesive element and the second adhesive element. Aligning the mesh, the first adhesive element and the second adhesive element may comprise aligning an outer periphery, or at least parts of an outer periphery, of the mesh, the first adhesive element and the second adhesive element respectively. Arranging the first adhesive element and the second adhesive element on opposite surfaces of the mesh at a second portion of the mesh to obtain a filter assembly may further comprise arranging and aligning the mesh, the first adhesive element and the second adhesive element by hand.

It is an advantage that by cutting of the mesh, the first adhesive element and the second adhesive element into a filter shape, prior to arranging, may allow for obtaining filter device(s) where the mesh, the first adhesive element and the second adhesive element has different filter shapes. The filter shape may be any desired shape/form. The filter shape may correspond to the opening at the portion of the housing of the hearing device.

The cutting of the mesh, the first adhesive element and the second adhesive element may be performed in a manner which per se is known in the art. The mesh, the first adhesive element and the second adhesive element may be cut in a desired size and shape e.g. a circular or an oval shape. Outer peripheries of the mesh, the first adhesive element and the second adhesive element may have the same size and shape subsequent to the cutting. The outer peripheries of the mesh, the first adhesive element and the second adhesive element may not have the same size and shape subsequent to the cutting. The cutting of the first adhesive element and the second adhesive element may further provide a perforation within the outer periphery of the first adhesive element and the second adhesive element.

In some embodiments, the mesh may comprise a protrusion. The protrusion of the mesh may be provided with a desired shape and a desired size. The protrusion of the mesh may facilitate arranging of the filter device in a desired position and a correct manner. For instance, the filter device may be arranged in a housing of a hearing device.

In some embodiments, the first adhesive element and the second adhesive element are provided in the form of double-sided tapes, wherein each respective double-sided tape is provided with two layers of protective sheets arranged on opposite surfaces of the respective double-sided tape. The method further comprises removing at least one protective sheet of each respective double-sided tape prior to arranging the first adhesive element and the second adhesive element on opposite surfaces of the mesh.

Thereby, the two layers of the protective sheets of each respective double-sided tape may protect surfaces of the respective double-sided tape with adhesive material against absorbing dust and contaminations prior to arranging the first adhesive element and the second adhesive element on opposite surfaces of the mesh. This in turn may allow for obtaining the filter device and in particular the closed portion of the filter device in a reliable and stable manner.

Alternatively, the first adhesive element and the second adhesive element may be provided in the form of single-sided tapes, wherein one surface of each respective single-sided tape is provided with a layer of protective sheet. The method further comprises removing the protective sheet of each respective single-sided tape prior to arranging the first adhesive element and the second adhesive element on opposite surfaces of the mesh.

Alternatively, one of the first adhesive element or the second adhesive element may be provided in the form of single-sided tapes and the other one of the first adhesive element or the second adhesive element may be provided in the form of double-sided tapes.

Thereby, the cutting of the filter assembly into a filter device may comprise additionally cutting through one or two protective sheet(s) provided on the surface of the first adhesive element and the second adhesive element away from the mesh. The first surface of the adhesive element may be configured to be adhesively attached to the mesh and the second surface of the adhesive element may be an opposite surface. The second surface of the adhesive element may optionally be configured to be attached to the housing of the hearing device or to the sealing element/PCB/microphone.

Thereby, the cutting of the first adhesive element and/or the second adhesive element, respectively, into a filter shape may comprise cutting through one or two protective sheet(s) provided on one or opposite surface(s) of the first adhesive element or the second adhesive element.

In any of the embodiments defined above, the surface of the tape, being arranged on a surface of the mesh, is used to close the openings/holes of the mesh at the second portion of the mesh to form the closed portion of the filter. The surface of the tape, not being arranged on a surface of the mesh, may be used for mounting the filter device to the housing of the hearing device, a sealing element, a microphone and/or a PCB, respectively. Alternatively, the mounting of the filter device to the housing of the hearing device, a sealing element, a microphone and/or a PCB may be obtained in a different manner than using the tape.

According to a second aspect, disclosed is a filter device for a hearing device. The filter device comprises a mesh comprising a first portion and a second portion, the second portion surrounding the first portion, a first adhesive element, and a second adhesive element. The first adhesive element and the second adhesive element are arranged on opposite surfaces of the mesh at the second portion of the mesh. The first adhesive element and the second adhesive element are pressed into the mesh to form a closed portion of the filter device. Whereby the first portion of the mesh forms an open portion of the filter device. Whereby the open portion of the filter device is configured to allow sound passing/travelling through the mesh. Whereby the closed portion of the filter device is configured to prevent sound from passing/travelling through the mesh.

The second aspect generally present the same or corresponding advantages as the first aspect. It is an advantage of the filter device that at least dust and particles with sizes larger than the size of the opening or holes of the mesh, are prevented from passing through the mesh at the open portion of the filter device. It is another advantage of the filter device that sound is allowed to pass through the mesh at the open portion of the filter device. It is yet another advantage of the filter device that sound leakage through the closed portion of the filter device is prevented or at least mitigated i.e. the closed portion of the filter device is not sound transparent. The mesh may comprise at least one first portion. The mesh may comprise at least one second portion.

According to a third aspect, disclosed is a hearing device. The hearing device comprises a filter device according to the second aspect. The hearing device further comprises a sealing element, wherein the sealing element is arranged adjacent to the filter device. The sealing element may be arranged adjacent to the closed portion of the filter device. The sealing element may be arranged adjacent to the at least one closed portion of the filter device. By adjacent is meant that the filter device is arranged immediately preceding or following the filter device and/or at least in close proximity to the filter device.

In an embodiment, the hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprise in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHZ, preferably a wavelength between 900 MHz and 6 GHZ. The first frequency may be 902 MHz to 928 MHz. The first frequency may be 2.4 to 2.5 GHZ. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

The third aspect generally present the same or corresponding advantages as the first and second aspects. The hearing device may further comprise a first input transducer e.g. a first microphone. The hearing device may further comprise a second input transducer e.g. a second microphone. The hearing device may further comprise a receiver. It is an advantage of the hearing device that internal leakage of sound/noise from the receiver into the first microphone and/or into the second microphone is prevented or at least mitigated, as the openings or holes of the mesh at the closed portion of the filter device are closed. It is another advantage of the hearing device that sound leakage into the first microphone and/or into the second microphone is prevented or at least mitigated. It is yet another advantage of the hearing device that sound leakage from the first microphone into the second microphone and vice versa is prevented or at least mitigated.

It is an advantage that the hearing device may further comprise a sealing element, as the addition of the sealing element allows for using/placing the filter device within the hearing device without gluing the filter device to a housing or internal components of the hearing device such as a printed circuit board (PCB) or the first microphone and/or the second microphone of the hearing device. This allows for dissembling the hearing device in a simple and user-friendly manner, as the housing of the hearing device and the components of the hearing device may be easily disassembled from each other in case of a need of replacing certain parts, such as the filter device, the housing of the hearing device, etc. An additional advantage of the addition of the sealing element may be that the sealing element is configured to compensate for tolerances of the filter device, i.e. production variations of the filter device, as well as tolerances of other internal components of the hearing device arranged adjacent to, around, in close proximity to or in communication with the filter device. The sealing element may be mounted to the filter device by removing at least one protective sheet of one of the double-sided tape of the filter device prior to arranging the sealing element adjacent to the filter device.

The sealing element may comprise an open portion and a closed portion. The open portion may be arranged at an inner portion of the sealing element. The open portion of the sealing element may be arranged in a manner aligned with the open portion of the filter device to allow for sound passage. For instance, the sealing element may be in the form of a ring. In this case, the open portion of the ring may be arranged above or under the open portion of the filter device to allow for sound passage. The closed portion of the sealing element may be arranged adjacent to the closed portion of the filter device to block for sound passage. In the case of the sealing element being in the form of the ring, the closed portion of the ring may be arranged above or under the closed portion of the filter device to prevent sound passage. The closed portion of the sealing element may cover/enclose the closed portion of the filter device completely. The closed portion of the sealing element may at least cover/enclose the closed portion of the filter device partially. The sound passage may be between the opening in the portion of the housing and the opening of the microphone/receiver. In the case of more than one microphone, the sound passage may be between at least one opening in the portion of the housing and at least one opening of microphones.

The sealing element may comprise a protrusion at the closed portion at one surface of the sealing element. The protrusion may hence surround the open portion of the sealing element. For instance, the sealing element may comprise a circular protrusion at one surface of the sealing element. The circular protrusion of the sealing element may be arranged upwards i.e. facing the housing. The circular protrusion of the sealing element may be arranged downwards i.e. facing a microphone or a PCB of the hearing device.

The sealing element may further comprise an indentation at the closed portion at one surface of the sealing element. The indentation may hence surround the open portion of the sealing element. For instance, the sealing element may comprise a circular protrusion at one surface of the sealing element and a circular indentation on the other surface of the sealing element. The indentation may be provided on the opposite surface of the sealing element as the protrusion. The circular indentation of the sealing element may be arranged upwards, i.e., facing the filter device. The indentation of the sealing element may allow the sealing element to “travel” e.g. move/bend/deflect when being under pressure, thus improving the sealing elements ability to compensate for tolerances between hearing device components, such as the filter device, the housing of the hearing device, the microphone, the PCB and/or other components adjacent to, in close proximity to or around or in communication with the filter device.

Alternatively, the hearing device may not comprise any sealing element. In this case, the filter device may be glued to the housing and/or internal components of the hearing device such as a printed circuit board (PCB) or a microphone of the hearing device. As an example, one surface of the filter device may be glued to the housing of the hearing device and the other surface of the filter device may be glued to an internal component of the hearing device, such as a printed circuit board (PCB) or a microphone of the hearing device.

According to a fourth aspect, disclosed is a method of assembling a hearing device. The method comprises providing a filter device according to the second aspect and/or the method according to the first aspect. The method further comprises providing a sealing element, a housing comprising an opening in a portion of the housing, and a microphone. The method further comprises arranging the filter device in between the microphone and the housing at the opening of the housing such that the open portion of the filter device is aligned with the opening in the portion of the housing. The method further comprises arranging the sealing element adjacent to the filter device.

According to a fifth aspect, disclosed is a method of assembling a hearing device. The method comprises providing a filter device according to the second aspect and/or the method according to the first aspect. The method further comprises providing a sealing element, a housing comprising an opening in a portion of the housing, and a receiver. The method further comprises arranging the filter device in between the receiver and the housing at the opening of the housing such that the open portion of the filter device is aligned with the opening in the portion of the housing. The method further comprises arranging the sealing element adjacent to the filter device.

The fourth and the fifth aspects generally present the same or corresponding advantages as the first, second, and third aspects. The filter device may be mounted to the housing at the opening of the housing by removing at least one protective sheet of one of the double-sided tape of the filter device prior to arranging the filter device in between the microphone and the housing. The sealing element may be mounted to the filter device by removing at least one protective sheet of one of the double-sided tape of the filter device prior to arranging the sealing element adjacent to the filter device. The method may further comprise aligning a microphone/receiver opening with the open portion of the filer device.

The present disclosure relates to different aspects including a method of manufacturing the filter device, the filter device, the hearing device, the method of assembling the hearing device, each yielding one or more of the benefits and advantages described in connection with the mentioned aspects, and each having one or more embodiments corresponding to the embodiments described in connection with the mentioned aspects and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIGS. 1a-1f schematically illustrate an exemplary method 100 of manufacturing a filter device 10.

FIGS. 2a-2d schematically illustrate another exemplary method 100 of manufacturing a filter device 10.

FIG. 3 schematically illustrates steps of an exemplary method 100 of manufacturing a filter device 10.

FIGS. 4a, 4b and 4c schematically illustrate three exemplary hearing devices 50 comprising a filter device 10.

FIGS. 4d and 4e schematically illustrate side views of two sealing elements 20 and FIG. 4f shows a top view of a sealing element 20.

FIG. 5 schematically illustrates steps of an exemplary method 200 of assembling a hearing device 50.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

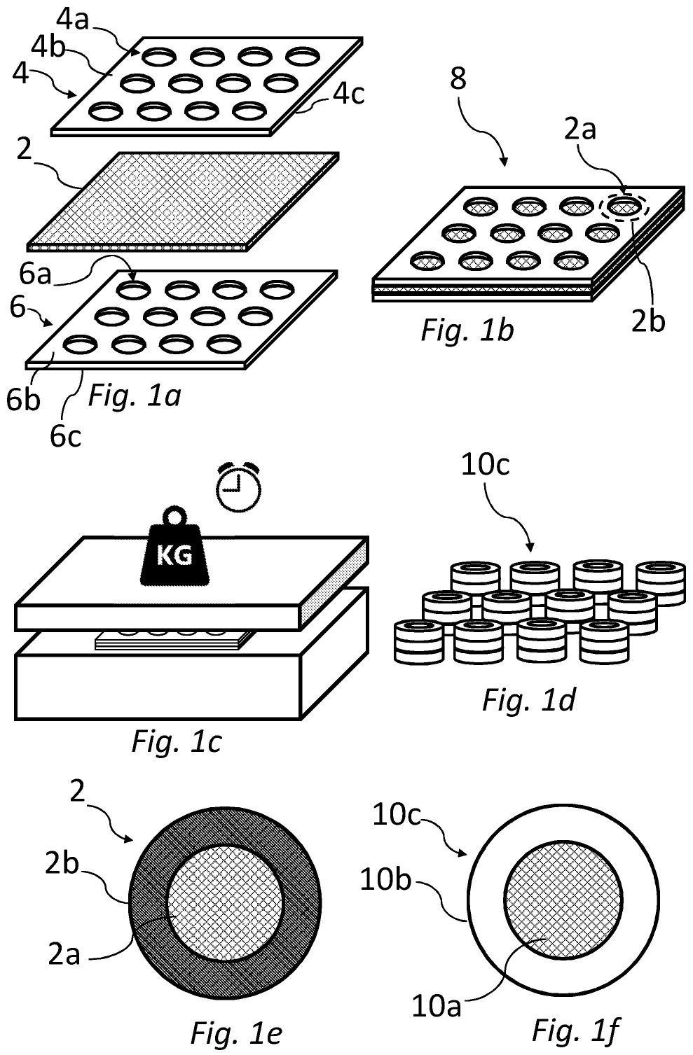

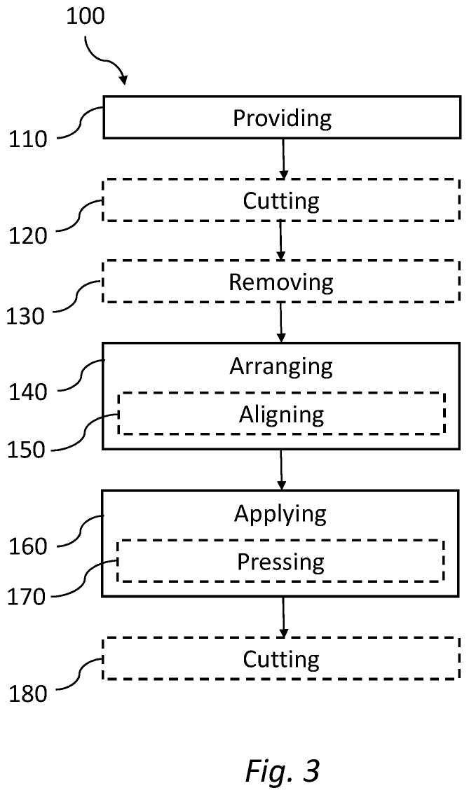

FIGS. 1a-1c schematically illustrates an exemplary method 100 of manufacturing a filter device 10. FIG. 3 schematically illustrates steps of an exemplary method 100 of manufacturing a filter device 10. The method 100 comprises providing 110 a mesh 2, a first adhesive element 4, and a second adhesive element 6.

In relation to FIGS. 1a and 3, the method 100 further comprises arranging 140 the first adhesive element 4 and the second adhesive element 6 on opposite surfaces of the mesh 2 at a second portion 2b of the mesh 2 to obtain a filter assembly 8. FIG. 1b shows an exemplary filter assembly 8.

FIGS. 1a-1c show that the mesh 2, the first adhesive element 4 and the second adhesive element 6 are in the form of a mesh sheet 2, a first adhesive sheet 4 and a second adhesive sheet 6, respectively. FIGS. 1a-1c show that each adhesive sheet comprises one or more perforation(s) 4a, 6a. FIG. 1a shows a first surface 4b of the first adhesive element 4 and a second surface 4c of the first adhesive element 4. FIG. 1a also shows a first surface 6b of the second adhesive element 6 and a second surface 6c of the second adhesive element 6. The first adhesive sheet 4 may be a single-sided or a double-sided tape. The second adhesive sheet 6 may be a single-sided or a double-sided tape. In relation to FIG. 1b and FIG. 3, the arranging 140 the first adhesive element 4 and the second adhesive element 6 may comprise aligning 150 the one or more perforation 4a of the first adhesive sheet 4 with the one or more perforation(s) 6a of the second adhesive sheet 6 at the second portion 2b of the mesh 2. By aligning the at least one perforation of the first adhesive sheet 4 with the at least one perforation 6a of the second adhesive sheet 6 is provided one set of aligned perforations of the first and second adhesive sheet 4, 6. FIG. 1b shows an obtained filter assembly 8 where the second portion 2b of the mesh 2 corresponds to portions of the mesh sheet 2 at/in between the perforations 4a, 6a of first adhesive sheet 4 and the second adhesive sheet. In FIG. 1b, the second portion 2b of the mesh 2 correspond to portions of the mesh sheet 2 covered by the first adhesive sheet 4 and the second adhesive sheet 6.

In relation to FIG. 1c and FIG. 3, the method 100 further comprises applying 160 a predetermined force to the filter assembly 8 for a predetermined period of time, thereby obtaining the filter device 10. FIG. 1c and FIG. 3, show that applying 160 the force may comprise pressing 170 the first adhesive element 4 and the second adhesive element 6 into the second portion 2b of the mesh 2.

FIGS. 1a, 1b, and 1c show an example of the filter device 10 which being cut out into one or more cut-out filter device 10c.

In relation to FIG. 1d and FIG. 3, the method 100 may further comprise cutting 180 the filter device 10 into one or more cut-out filter device(s) 10c, subsequent to applying 160 the predetermined force for the predetermined period of time thereby obtaining the filter device 10. Cutting 180 the filter device 10 into one or more filter device(s) 10c comprises cutting the outer periphery of the cut-out filter device(s) 10c, wherein, as an example shown in FIG. 1d, the cut periphery of one cut-out filter device 10c surrounds one set of aligned perforations of the first and second adhesive sheet 4, 6. In FIG. 1d a plurality of cut-out filter devices 10c are shown, as an example, each having a circular shape.

In FIG. 1f, a top view of an exemplary cut-out filter device 10c is shown. FIG. 1f shows that the cut-out filter device 10c comprises a closed portion 10b at the second portion 2b of the mesh 2. FIG. 1f further shows that the cut-out filter device 10c comprises an open portion 10a at the first portion 2a of the mesh 2. FIG. 1f shows that where the first adhesive element 4 and the second adhesive element 6 are pressed 170 into the mesh 2 forms a closed portion 10b of the cut-out filter device 10c. FIG. 1f further shows that the first portion 2a of the mesh 2 forms an open portion 10a of the cut-out filter device 10c. The open portion 10a of the cut-out filter device 10c is configured to allow sound passing through the mesh 2. The closed portion 10b of the cut-out filter device 10c is configured to prevent sound from passing through the mesh 2.

FIG. 1e shows that the first adhesive element 4 and the second adhesive element 6 are pressed 170 into the mesh 2. FIG. 1e shows that the second portion 2b of the mesh 2 surrounds a first portion 2a of the mesh 2. In FIG. 1e, the second portion 2b of the mesh 2 is shown darker than the first portion 2a of the mesh 2.

Alternatively, not shown in FIG. 1d, the cut-out filter device 10c may comprise at least one open portion 10a. Optionally, the cut-out filter device 10c may have any shape as desired, as well as the shape of the open portion 10a may have any shape as desired, such as one or more circles, rectangles, and/or slits. In relation to FIG. 1e, a top view of a mesh 2 of an exemplary cut-out filter device 10c is shown. The mesh 2 comprises a first portion 2a and a second portion 2b, wherein the second portion 2b surrounds the first portion 2a.

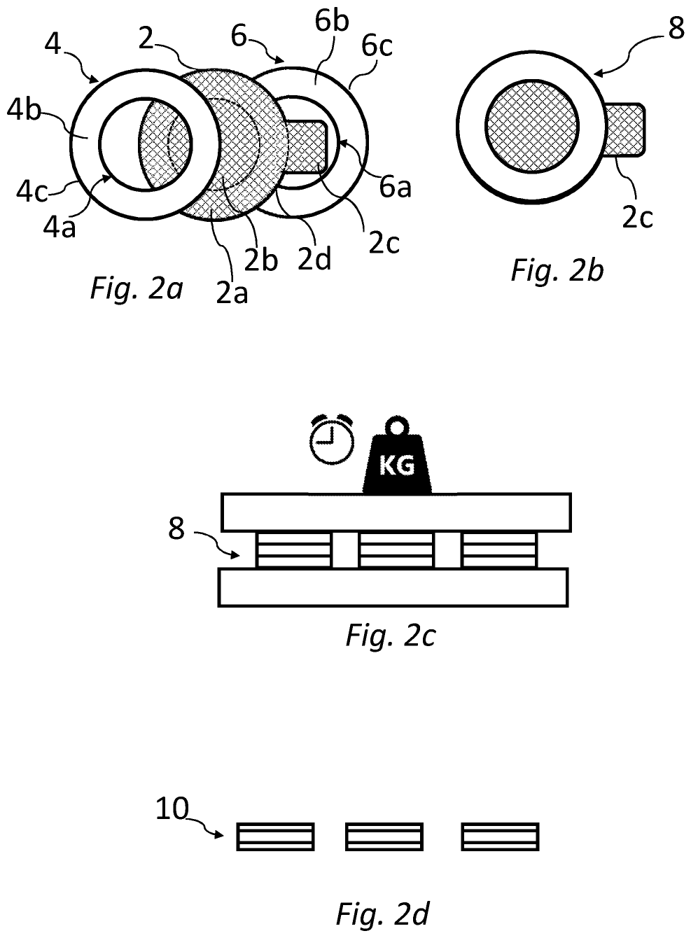

FIGS. 2a-d schematically illustrate another exemplary method 100 of manufacturing a filter device 10.

In relation to FIG. 2a and FIG. 3, the method 100 further comprises (separately) cutting 120 the first adhesive element 4, the mesh 2 and the second adhesive element 6 into a filter shape prior to arranging 140 the first adhesive element 4 and the second adhesive element 6 on opposite surfaces of the mesh 2. The first adhesive element 4 and the second adhesive element 6 may (separately) be cut into one filter shape, wherein the mesh 2 may be cut into another filter shape. Cutting the first and the second adhesive element 4, 6 into a filter shape may comprise cutting an outer periphery of the first and the second adhesive element 4, 6 and cutting a perforation within the outer periphery of the first and the second adhesive element 4, 6. Cutting the mesh 2 into a filter shape may comprise cutting an outer periphery of the mesh 2. The first adhesive element 4 and the second adhesive element 6 may be cut out from an adhesive sheet provided with one protective sheet protecting an adhesive layer on one surface of the adhesive sheet, such as sheet of single-sided tape. The first adhesive element 4 and the second adhesive element 6 may be cut out from an adhesive sheet provided with two protective sheets protecting respectively two adhesive layers on opposite surfaces of the adhesive sheet, such as a sheet of double-sided tape. FIGS. 2a and 2b show that the mesh 2 optionally may comprise a protrusion 2c.

FIG. 2a shows a first surface 4b of the first adhesive element 4 and a second surface 4c of the first adhesive element 4. FIG. 2a also shows a first surface 6b of the second adhesive element 6 and a second surface 6c of the second adhesive element 6.

FIGS. 2b-2d show similar steps of the method 100, as those shown in accordance with FIGS. 1b-1d. Prior to arranging 140 the first adhesive element 4 and the second adhesive element 6 on opposite surfaces of the mesh 2 the method may further comprise removing 130 a protective sheet from the first adhesive element 4 and the second adhesive element 6, respectively. FIG. 2d further shows how the height of the filter device 10 may be smaller than the height of the filter assembly 8 after the first adhesive element 4 and the second adhesive element 6 are pressed 170 into the mesh 2.

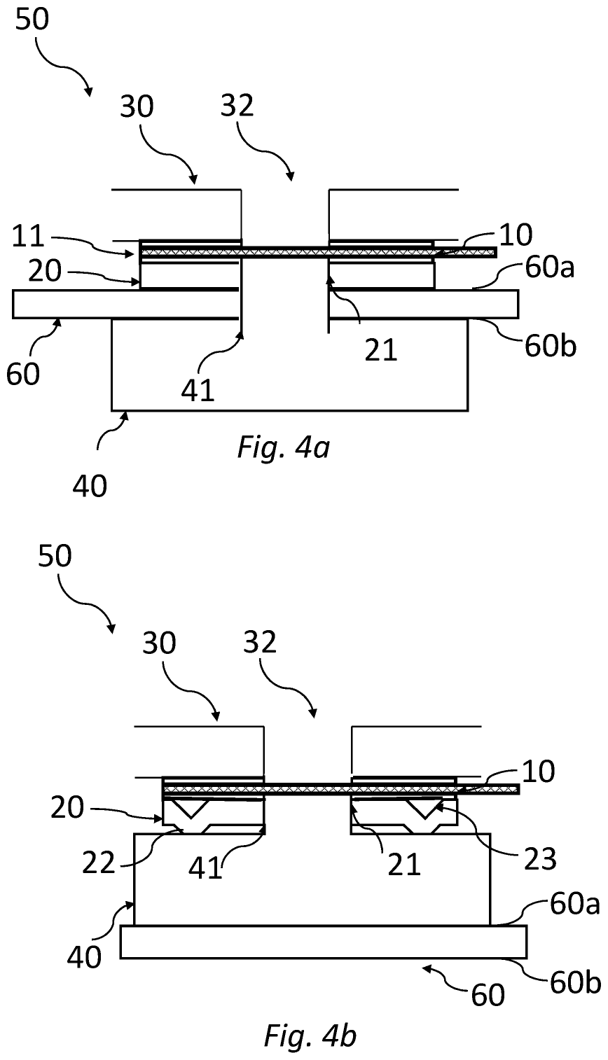

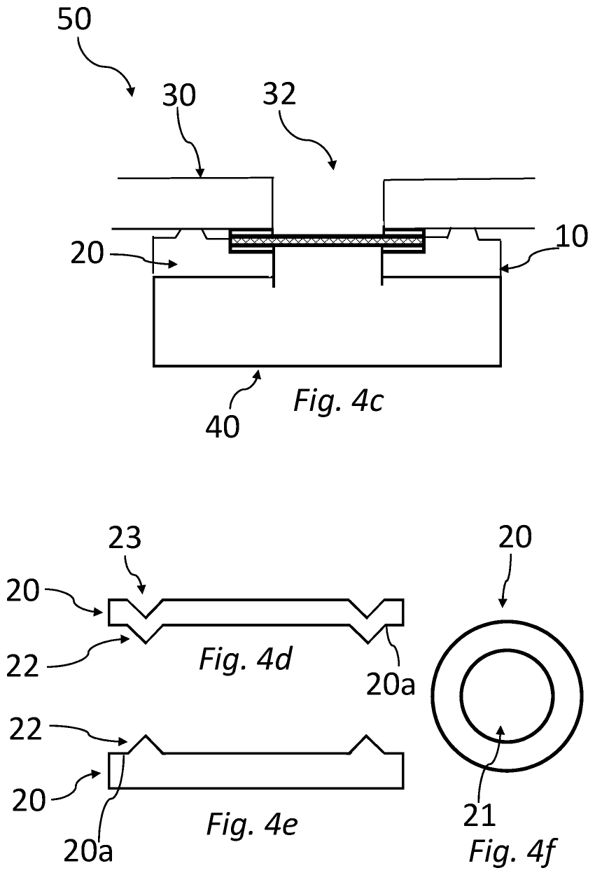

FIGS. 4a-4c schematically illustrate three exemplary hearing devices 50. The hearing devices 50 comprise a filter device 10 and a sealing element 20. The filter device 10 of FIGS. 4a-4c may be manufactured as shown in FIGS. 1a-1f or as shown in FIGS. 2a-2d. FIGS. 4a-c show that the sealing element 20 is arranged adjacent to the filter device 10. The sealing element 20 may be similar shape of the closed portion 10b of the filter device 10, which at least partly in contact with the closed portion 10b thereby providing sealing. Shown as an example in FIG. 4a-c, the sealing element 20 may be a ring shape and thereby comprising an open portion 21 of the sealing element 20. The sealing element 20 may comprises at least one protrusion and/or at least one indentation in a suitable form and/or shapes. FIGS. 4d and 4e further show multiple examples that the sealing element 20 may exemplary comprise a circular protrusion 22. FIG. 4e shows an example that a circular protrusion 22 is arranged at one surface 20a of sealing element 20. FIG. 4d shows an example that the sealing element 20 may comprise an indentation 23. FIG. 4f shows an exemplary top view of a sealing element 20. FIG. 4f shows an exemplary open portion 21 of the sealing element 20.

The hearing device 50 further comprises a housing 30 with at least one opening in a portion of the housing 32, such as a sound inlet 32, and a microphone 40 having a microphone opening 41 or a sound outlet, and a receiver having a receiver opening (not shown). In FIG. 4b, the circular protrusion 22 is arranged such that it faces downwards, i.e., faces the microphone 40 of the hearing device. In FIG. 4c, the circular protrusion 22 is arranged such that it faces upwards, i.e., faces the housing 30 of the hearing device 50. FIG. 4b further show that the sealing element 20 may comprise a circular indentation 23. In the case of arranging the circular protrusion 22 to the receiver, the circular protrusion 22 may be arranged such that it faces downwards, i.e., faces the receiver of the hearing device.

It is an advantage that internal sound/noise from the hearing device 50 and/or external sound/noise entering the hearing device 50 through one or more sound inlets 32 or other openings in the hearing device 50 cannot travel through the closed portion 10b of the filter device 10, see FIG. 1f, of the filter device 10, into the microphone 40.

FIG. 4a show that the hearing device may further comprise a printed circuit board (PCB) 60. The microphone 40 may be mounted, such as soldered or glued, to the PCB 60 on either upper surface 60a or lower surface 60b of the PCB 60, see FIGS. 4a and 4b. Depending on the microphone is mounted on which surface of the PCB 60, an assembly of the filter device 10 and sealing element 20 may thus be placed in between the housing 30 of the hearing device and the PCB 60. Alternatively, the assembly of the filter device 10 and sealing element 20 may be placed in between the housing 30 of the hearing device and the microphone 40.

The housing 30 and/or the PCB 60 may comprise at least one indentation (not shown). The indentation comprised in the housing 3 and/or the PCB 60 may correspond to at least one protrusion 22 of the sealing element 20 (shown in FIG. 4d, FIG. 4e).

FIG. 4c show how the sealing element 20 additionally may be used to block transmission/travel of sound/noise through the closed portion 10b, see FIG. 1f, of the filter device 10, into the microphone 40.

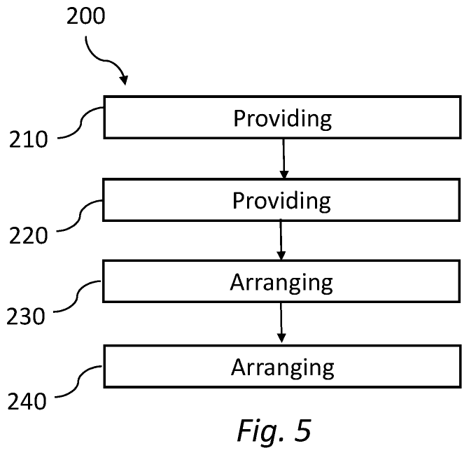

FIG. 5 schematically illustrates steps of an exemplary method 200 of assembling a hearing device 50. FIG. 5 shows that the method comprises providing 210 a filter device 10. The filter device 10 may be provided in accordance with any of FIGS. 1-3. FIG. 5 shows that the method 200 further comprises providing 220 a sealing element 20, a housing 30 comprising an opening 32 in a portion of the housing 30, and a microphone 40. FIG. 5 shows that the method 200 further comprises arranging 230 the filter device 10 in between the microphone 40 and the housing 30 at the opening 32 of the housing 30 such that the open portion 10a of the filter device 10 is aligned with the opening 32 in the portion of the housing 30. FIG. 5 shows that the method 200 further comprises arranging 240 the sealing element 20 adjacent to the filter device 10, such as in between the microphone 40 and the filter device 10 and/or in between the microphone 40 and the housing 30. The method 200 may further comprise aligning a microphone opening 41 with the open portion 10a of the filer device 10.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items:

1. A method (100) of manufacturing a filter device (10), the method (100) comprising:
   providing (110) a mesh (2), a first adhesive element (4), and a second adhesive element (6),
   arranging (140) the first adhesive element (4) and the second adhesive element (6) on opposite surfaces of the mesh (2) at a second portion (2b) of the mesh (2) to obtain a filter assembly (8), the second portion (2b) of the mesh (2) surrounding a first portion (2a) of the mesh (2),
   applying (160) a predetermined force to the filter assembly (8) for a predetermined period of time, thereby obtaining a filter device (10) comprising a closed portion (10b) of the filter device (10) at the second portion (2b) of the mesh (2), and comprising an open portion (10a) of the filter device (10) at the first portion (2a) of the mesh (2).
2. A method (100) of manufacturing a filter device (10), the method (100) comprising:
   providing (110) a mesh (2), a first adhesive element (4), and a second adhesive element (6),
   arranging (140) the first adhesive element (4) and the second adhesive element (6) on opposite surfaces of the mesh (2) at a second portion (2b) of the mesh (2) to obtain a filter assembly (8), the second portion (2b) of the mesh (2) surrounding a first portion (2a) of the mesh (2),
   applying (160) a predetermined force to the filter assembly (8) for a predetermined period of time, thereby obtaining a filter device (10) comprising at least a closed portion (10b) of the filter device (10) at the second portion (2b) of the mesh (2), and comprising at least an open portion (10a) of the filter device (10) at the first portion (2a) of the mesh (2).
3. The method (100) according to item 1 or 2, wherein applying (160) the force comprises pressing (170) the first adhesive element (4) and the second adhesive element (6) into the second portion (2b) of the mesh (2).
4. The method (100) according to any of the preceding items, wherein the predetermined force is at least 0.2 MPa, and wherein the predetermined period of time is at least 1 sec.
5. The method (100) according to any of the preceding items, wherein each of the first adhesive element (4) and the second adhesive element (6) comprises at least one perforation (4a, 6a), and wherein arranging (140) the first adhesive element (4) and the second adhesive element (6) comprises aligning (150) the at least one perforation (4a) of the first adhesive element (4) with the at least one perforation (6a) of the second adhesive element (6) at the second portion (2b) of the mesh (2).
6. The method (100) according to any of the preceding items, wherein the mesh (2), the first adhesive element (4) and the second adhesive element (6) are provided as a mesh sheet (2), a first adhesive sheet (4) and a second adhesive sheet (6), respectively.
7. The method (100) according to any of the preceding items, wherein the method (100) further comprises cutting (180) the filter device (10) into one or more cut-out filter devices (10) subsequent to applying (160) the predetermined force for the predetermined period of time.
8. The method (100) according to any of the items 1-5, wherein the mesh (2), the first adhesive element (4) and the second adhesive element (6) are provided as a mesh (2), a first adhesive element (4) and a second adhesive element (6), respectively, cut into one or more filter shape and wherein the method (100) further comprises separately cutting (120) the first adhesive element (4), the mesh (2) and the second adhesive element (6) into one or more filter shapes prior to arranging (140) the first adhesive element (4) and the second adhesive element (6) on opposite surfaces of the mesh (2).
9. The method (100) according to any of the preceding items, wherein the first adhesive element (4) and the second adhesive element (6) are provided in the form of double-sided tapes, wherein each respective double-sided tape is provided with two layers of protective sheets arranged on opposite surfaces of the respective double-sided tape, and wherein the method (100) further comprises removing (130) at least one protective sheet of each respective double-sided tape prior to arranging (140) the first adhesive element (4) and the second adhesive element (6) on opposite surfaces of the mesh (2).
10. The method (100) according to any of the items 1-9, wherein by applying (160) the predetermined force to the filter assembly (8) for the predetermined period of time, openings/holes of the mesh (2) at the second portion (2b) of the mesh (2) become completely or at least partially filled with adhesive material of the first adhesive element (4) and/or the second adhesive element (4).
11. The method (100) according to any of the items 1-9, wherein the closed portion (10b) of the filter device is not sound transparent.
12. A filter device (10) for a hearing device (50), the filter device (10) comprising:
   a mesh (2) comprising a first portion (2a) and a second portion (2b), the second portion (2b) surrounding the first portion (2a),
   a first adhesive element (4), and
   a second adhesive element (6),
Wherein the first adhesive element (4) and the second adhesive element (6) are arranged (140) on opposite surfaces of the mesh (2) at the second portion of the mesh (2b), and wherein the first adhesive element (4) and the second adhesive element (6) are pressed (170) into the mesh (2) to form a closed portion (10b) of the filter device (10), whereby the first portion (2a) of the mesh (2) forms an open portion (10a) of the filter device (10),
whereby the open portion (10a) of the filter device (10) is configured to allow sound passing/travelling through the mesh (2), and whereby the closed portion (10b) of the filter device (10) is configured to prevent sound from passing/travelling through the mesh (2).
13. A hearing device (50) comprising a filter device (10) according to item 12, and a sealing element (20), wherein the sealing element (20) is arranged adjacent to the filter device (10).
14. A filter device (10) for a hearing device (50), the filter device (10) comprising:
   a mesh (2) comprising at least one first portion (2a) and a at least one second portion (2b), the second portion (2b) surrounding the first portion (2a),
   a first adhesive element (4), and
   a second adhesive element (6),
Wherein the first adhesive element (4) and the second adhesive element (6) are arranged (140) on opposite surfaces of the mesh (2) at the at least one second portion of the mesh (2b), and wherein the first adhesive element (4) and the second adhesive element (6) are pressed (170) into the mesh (2) to form at least one closed portion (10b) of the filter device (10), whereby the at least one first portion (2a) of the mesh (2) forms at least one open portion (10a) of the filter device (10),
whereby the at least one open portion (10a) of the filter device (10) is configured to allow sound passing/travelling through the mesh (2), and whereby the at least one closed portion (10b) of the filter device (10) is configured to prevent sound from passing/travelling through the mesh (2).
15. A hearing device (50) comprising a filter device (10) according to item 14, and a sealing element (20), wherein the sealing element (20) is arranged adjacent to the at least one close portion of the filter device (10).
16. A method (200) of assembling a hearing device (50), the method (200) comprising:
   providing (210) a filter device (10) according to item 12 or 14 and/or the method (100) of any of the items 1-11,
   providing (220) a sealing element (20), a housing (30) comprising an opening (32) in a portion of the housing (30), and a microphone (40),
   arranging (230) the filter device (10) in between the microphone (40) and the housing (30) at the opening (32) of the housing (30) such that the open portion (10a) of the filter device (10) is aligned with the opening (32) in the portion of the housing (30), and
   arranging (240) the sealing element (20) adjacent to the filter device (10).

### LIST OF REFERENCES

2 Mesh, Mesh sheet
2a First portion of the mesh
2b Second portion of mesh
2c Protrusion
4 First adhesive element, First adhesive sheet
4a Perforation of first adhesive element, Perforation of first adhesive sheet
4b First surface of first adhesive element
4c Second surface of first adhesive element
6 Second adhesive element, Second adhesive sheet
6a Perforation of second adhesive element, Perforation of second adhesive sheet
6b First surface of second adhesive element
6c Second surface of second adhesive element
8 Filter assembly
10 Filter device
10a Open portion of a filter device
10b Closed portion of a filter device
10c Cut-out filter device
20 Sealing element
20a One surface of sealing element
21 Open portion of the sealing element
22 Circular protrusion
23 Circular indentation
30 Housing
32 Opening in a portion of housing, Sound inlet
40 Microphone
41 Microphone opening
50 Hearing device
60 Printed circuit board (PCB)
60a Upper surface of PCB
60b Lower surface of PCB
100 Method of manufacturing a filter device
110 Method step of providing
120 Methods step of cutting
130 Method step of removing
140 Method step of arranging
150 Method step of aligning
160 Method step of applying
170 Method step of pressing
180 Method step of cutting
200 Method of assembling a hearing device
210 Method step of providing
220 Method step of providing
230 Method step of arranging
240 Method step of arranging

1. A method of manufacturing a filter device, the method comprising:
obtaining a mesh, a first adhesive element, and a second adhesive element, wherein the mesh comprises a first portion and a second portion surrounding the first portion;
arranging the first adhesive element and the second adhesive element on opposite surfaces of the mesh at the second portion of the mesh to obtain a filter assembly; and
applying a force to the filter assembly for a period of time to create the filter device, wherein the created filter device comprises a closed portion corresponding to the second portion of the mesh, and wherein the created filter device comprises an open portion corresponding to the first portion of the mesh.

2. The method of claim 1, wherein the force has a predetermined force value.

3. The method of claim 2, wherein the predetermined force value is at least 0.2 MPa.

4. The method of claim 1, wherein the period has a predetermined period value.

5. The method of claim 4, wherein the predetermined period value is at least 1 sec.

6. The method of claim 1, wherein the act of applying the force comprises pressing the first adhesive element and the second adhesive element towards the second portion of the mesh.

7. The method of claim 6, wherein at least a part of the first adhesive element and/or at least a part of the second adhesive element is pressed into the second portion of the mesh.

8. The method of claim 1, wherein each of the first adhesive element and the second adhesive element comprises at least one perforation, and wherein the act of arranging the first adhesive element and the second adhesive element comprises:
aligning the at least one perforation of the first adhesive element with respect to the mesh, and
aligning the at least one perforation of the second adhesive element with respect to the mesh.

9. The method of claim 1, wherein the mesh, the first adhesive element, and the second adhesive element are obtained as a part of a mesh sheet, a part of a first adhesive sheet, and a part of a second adhesive sheet, respectively.

10. The method of claim 9, wherein the act of arranging comprises arranging the first adhesive sheet and the second adhesive sheet on opposite surfaces of the mesh sheet to obtain the filter assembly.

11. The method of claim 1, further comprising cutting the filter device into one or more cut-out filter devices subsequent to the act of applying the force.

12. The method of claim 1, further comprising:
obtaining a mesh sheet, a first adhesive sheet, and a second adhesive sheet;
cutting the mesh sheet to obtain the mesh;
cutting the first adhesive sheet to obtain the first adhesive element; and
cutting the second adhesive sheet to obtain the second adhesive element.

13. The method of claim 12, wherein the acts of cutting are performed beore the act of arranging the first adhesive element and the second adhesive element on the opposite surfaces of the mesh.

14. The method of claim 1, wherein the first adhesive element is a double-sided tape having opposite surfaces that are coupled respectively to two layers of protective sheets, and wherein the method further comprises removing at least one of the protective sheets from the double-sided tape prior to arranging the first adhesive element on one of the opposite surfaces of the mesh.

15. The method of claim 1, wherein the second adhesive element is a double-sided tape having opposite surfaces that are coupled respectively to two layers of protective sheets, and wherein the method further comprises removing at least one of the protective sheets from the double-sided tape prior to arranging the second adhesive element on one of the opposite surfaces of the mesh.

16. A filter device for a hearing device, the filter device comprising:
a mesh comprising a first portion and a second portion, the second portion surrounding the first portion;
a first adhesive element; and
a second adhesive element;
wherein the first adhesive element and the second adhesive element are on opposite surfaces of the mesh at the second portion of the mesh;
wherein the first adhesive element, the second adhesive element, and the second portion of the mesh form a closed portion of the filter device, and wherein the first portion of the mesh forms an open portion of the filter device; and
wherein the open portion of the filter device is configured to allow sound passing/travelling through the mesh, and wherein the closed portion of the filter device is a sound barrier.

17. The filter device of claim 16, wherein at least a part of the first adhesive element and/or at least a part of the second adhesive element is in the second portion of the mesh.

18. A hearing device comprising the filter device of claim 16, and a sealing element.

19. The hearing device of claim 18, wherein the sealing element is between the filter device and a component of the hearing device.

20. A method of assembling a hearing device, the method comprising:
obtaining the filter device of claim 15;
obtaining a sealing element, a housing comprising an opening, and a microphone,
arranging the filter device between the microphone and the housing at the opening of the housing, such that the open portion of the filter device is aligned with the opening of the housing, and
arranging at least a part of the sealing element between the filter device and a component of the hearing device.
